(19) United States
(12) Patent Application Publication
(10) Pub. No.: US 2005/0167422 A1
(43) Pub. Date: Aug. 4, 2005

(54) Ceramics heater for semiconductor production system

(76) Inventors: Yoshifumi Kachi, Hyogo (JP); Akira Kuibira, Hyogo (JP); Hirohiko Nakata, Itami-shi Hyogo (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(21) Appl. No.: 10/500,736

(22) PCT Filed: Mar. 20, 2003
(86) PCT No.: PCT/JP03/03482

(30) Foreign Application Priority Data
Oct. 24, 2002 (JP) 2002-309386

(51) Int. Cl. H05B 3/10

(52) U.S. Cl. 219/548; 219/546

(57) ABSTRACT

For semiconductor manufacturing equipment a ceramic susceptor is made available in which the temperature uniformity in the surface of a wafer during heating operations is enhanced by keeping fluctuations in the shape of the susceptor—particularly in the outer diameter along the thickness at normal temperature—under control. The ceramic susceptor (1) for semiconductor manufacturing equipment has a resistive heating element (3) on a surface of or inside ceramic substrates (2a), (2b). The difference between the maximum outer diameter and minimum outer diameter along the thickness of the ceramic susceptor when not heating is 0.8% or less of the average diameter along the wafer-support side. A plasma electrode may be arranged on a surface of or inside the ceramic substrates (2a), (2b) of the ceramic susceptor (1). The ceramic substrates (2a), (2b) are preferably made of at least one selected from aluminum nitride, silicon nitride, aluminum oxynitride, and silicon carbide.

### TECHNICAL FIELD

The present invention relates to ceramic susceptors used to hold and heat wafers in semiconductor manufacturing equipment in which specific processes are carried out on the wafers in the course of semiconductor manufacture.

### BACKGROUND ART

Various structures have been proposed to date for ceramic susceptors used in semiconductor manufacturing equipment. Japanese Examined Pat. App. Pub. No. H06-28258, for example, proposes a semiconductor wafer heating device equipped with a ceramic susceptor that is installed in a reaction chamber and has an embedded resistive heating element, and a pillar-like support member that is provided on the surface of the susceptor other than its wafer-heating face and forms a gastight seal between it and the chamber.

In order to reduce manufacturing costs, a transition to wafers of larger diametric span—from 8-inch to 12-inch in outer diameter—is in progress, resulting in the diameter of the ceramic susceptor that holds the wafer increasing to 300 mm or more. At the same time, temperature uniformity of within ±1.0%, and preferably within ±0.5%, in the surface of the wafer heated by the ceramic susceptor is being called for.

To meet this demand for improved temperature uniformity, research has focused on improving the circuit pattern of the resistive heating element provided in the ceramic susceptor. Satisfying this need for improved temperature uniformity in the wafer surface has, however, become increasingly difficult as the diameter of the ceramic susceptor has increased.

Patent Reference 1

Japanese Examined Pat. App. Pub. No. H06-28258.

As described above, conventional efforts to improve temperature uniformity have been directed to improving the circuit pattern of the resistive heating element in the ceramic susceptor in order to uniformly heat the wafer-support side. As wafer diameter has increased in recent years, however, it has become increasingly difficult to maintain the required temperature uniformity across the wafer surface.

For example, the pattern of the resistive heating element formed on the surface of or inside the ceramic susceptor is designed and arranged so as to uniformly heat the surface on which the wafer is supported. The shape designed for the ceramic susceptor itself, on the other hand, is created on the assumption that thermal conduction along the circumferential direction and heat radiation from the peripheral area are uniform.

In the course of ceramic susceptor manufacture, the susceptor periphery is machined to a specified outer diameter by a polishing operation, where a problem has been that the stipulated dimension is simply the average outer diameter. This has meant that along with the transition to larger-diameter wafers, in practice irregularities in susceptor shape have increased-which has included greater fluctuations in the outer diameter of the ceramic susceptor-and such irregularities have become a barrier to improving the temperature uniformity in the surface of wafers processed on the susceptors.

### DISCLOSURE OF INVENTION

An object of the present invention, in view of such circumstances to date, is for semiconductor manufacturing equipment to make available a ceramic susceptor with which wafer-surface temperature uniformity is enhanced by keeping irregularities in the shape of the ceramic susceptor—particularly fluctuations in outer diameter along the susceptor thickness—under control.

To achieve this object the present invention affords for semiconductor manufacturing equipment a ceramic susceptor having a resistive heating element on a surface of or inside a ceramic substrate, the ceramic susceptor characterized in that the difference between a maximum outer diameter and a minimum outer diameter along the susceptor thickness is 0.8% or less of the average outer diameter along the susceptor wafer-support side when not heating.

The ceramic substrates in the foregoing ceramic susceptor of the present invention for semiconductor manufacturing equipment are preferably made of at least one a ceramic selected from aluminum nitride, silicon nitride, aluminum oxynitride, and silicon carbide.

Furthermore, the resistive heating element in the foregoing ceramic susceptor of the present invention for semiconductor manufacturing equipment is preferably made of at least one metal selected from tungsten, molybdenum, platinum, palladium, silver, nickel, and chrome.

Additionally a plasma electrode furthermore may be disposed on a surface of or inside the ceramic substrate for the foregoing ceramic susceptor of the present invention for semiconductor manufacturing equipment.

### BRIEF DESCRIPTION OF DRAWINGS

FIG. 1 is a schematic sectional view illustrating one specific example of a ceramic susceptor according to the present invention; and

FIG. 2 is a schematic sectional view illustrating a separate specific example of a ceramic susceptor according to the present invention.

### BEST MODE FOR CARRYING OUT THE INVENTION

Having studied the shape of the ceramic susceptor itself as a factor inhibiting improvement in temperature uniformity in the wafer surface, the present inventors focused on irregularity in the outer diameter along the thickness of the ceramic susceptor. More specifically, the present inventors realized that whereas conventionally only the average outer diameter of ceramic susceptors for semiconductor manufacturing equipment has been prescribed, the difference between the long and short axes if the susceptor has turned out elliptically shaped, and irregularity in the outer diameter along the thickness of the susceptor originating in the perpendicularity of the circumferential surface of the susceptor, more than appreciably affect wafer surface temperature uniformity.

In actual manufacture of ceramic susceptors, fluctuations in the outer diameter along the thickness are liable to become large. Because heat radiation per unit area is constant, in that portion of the susceptor where the outer diameter is greater—i.e., the portion where the peripheral unit area is greater—the amount of radiant heat will be larger; conversely the amount of radiant heat will be smaller that susceptor portion where the outer diameter is smaller. The heat emanation being the smaller in the smaller outer diameter portion of the ceramic susceptor and being the larger in the larger outer diameter portion produces temperature unevenness in susceptors, which on diametrically larger ceramic susceptors has a pronounced effect that cannot be overlooked.

In addressing this issue, the present inventors discovered that the temperature uniformity of the wafer surface during the wafer-heating process can be improved to ±1.0% or better by making the difference between a maximum outer diameter and minimum outer diameter of the ceramic susceptor along the thickness when not heating (i.e., at normal temperature) be 0.8% or less of the average outer diameter along the wafer-support side.

More specifically, letting Dₐᵥₑ be the average outer diameter of the ceramic susceptor wafer-support side, and Dₘₐₓ and Dₘᵢₙ be the maximum and minimum susceptor outer diameters along the thickness in an arbitrary plane, then the outer-diameter fluctuation parameter Dₚ is defined as Dₚ=(D_{max-D}ₘᵢₙ)/Dₐᵥₑ. By thus controlling outer-diameter fluctuation parameter Dₚ to 0.8% or less, the temperature uniformity of the wafer surface can be brought within ±0.5% in ceramic susceptors whose thermal conductivity is 100 W/mK or more, and within ±1.0% in ceramic susceptors whose thermal conductivity is 10 to 100 W/mK.

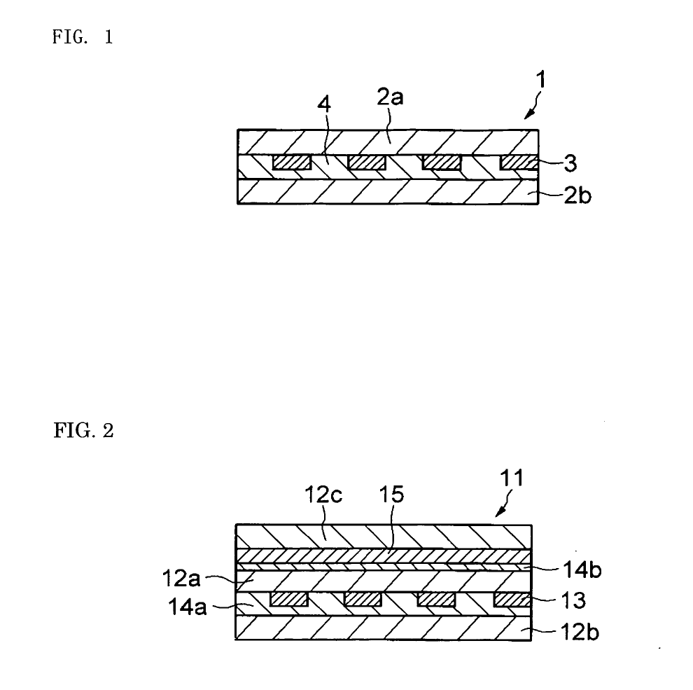

The specific structure of a ceramic susceptor according to the present invention is described next with reference to FIG. 1 and FIG. 2. The ceramic susceptor 1 shown in FIG. 1 has a resistive heating element 3 with a predetermined circuit pattern provided on one surface of a ceramic substrate 2a, and a separate ceramic substrate 2b bonded onto the same surface of the ceramic substrate 2a by means of an adhesive layer 4 of glass or ceramic. Here, the circuit pattern of the resistive heating element 3 is defined so that the line width and line interval will be, for example, 5 mm or less, more preferably 1 mm or less.

The ceramic susceptor 11 shown in FIG. 2 is furnished with an internal resistive heating element 13 and a plasma electrode 15. More specifically, a ceramic substrate 12a having the resistive heating element 13 on one surface thereof and a ceramic substrate 12b are bonded by an adhesive layer 14a similarly as with the ceramic susceptor shown in FIG. 1. At the same time, a separate ceramic substrate 12c provided with a plasma electrode 15 is bonded to the other side of the ceramic substrate 12a by means of a glass or ceramic adhesive layer 14b.

It should be understood that instead of bonding respective ceramic substrates to manufacture the ceramic susceptors, the ceramic susceptors shown in FIG. 1 and FIG. 2 can alternatively be manufactured by preparing approximately 0.5 mm thick green sheets, print-coating a conductive paste in the circuit pattern of the resistive heating element and/or plasma electrode on respective green sheets, laminating these green sheets together with other green sheets as needed to achieve the required thickness, and then simultaneously sintering the multiple green sheets to unite them.

### EMBODIMENTS

Embodiment 1

A sintering additive and a binder were added to, and dispersed into and mixed with, aluminum nitride (AlN) powder using a ball mill. After drying with a spray dryer, the powder blend was press-molded into 1-mm thick, 380-mm diameter disks. The molded disks were degreased in a non-oxidizing atmosphere at a temperature of 800° C., and then sintered for 4 hours at 1900° C., producing sintered AlN compacts. The thermal conductivity of the resulting AlN sinters was 170 W/mK. The circumferential surface of each sintered AlN compact was then polished to an outer diameter of 300 mm to prepare two AlN substrates for a ceramic susceptor.

A paste of tungsten powder and sintering additive kneaded together with a binder was then print-coated on the surface of one of these AlN substrates, forming the specific circuit pattern of the resistive heating element. This AlN substrate was degreased in a non-oxidizing atmosphere at a temperature of 800° C. and then baked at 1700° C., producing a tungsten resistive heating element. A paste of Y₂O₃ adhesive agent kneaded with a binder was print-coated on the surface of the remaining AlN substrate, which was then degreased at 500° C. The adhesive layer of this AlN substrate was then overlaid on the side of the AlN substrate on which the resistive heating element was formed, and the substrates were bonded together by heating at 800° C., thereby producing a ceramic susceptor of AlN.

The circumferential surface of the ceramic susceptor produced by bonding was once more polished to yield a predetermined outer-diameter fluctuation parameter Dₚ at normal temperature. Having the configuration represented in FIG. 1, seven sample ceramic susceptors in which the outer-diameter fluctuation parameter Dₚ was varied as indicated in Table I were prepared as just described.

It will be understood that here the outer-diameter fluctuation parameter Dₚ is defined as Dₚ=(Dₘₐₓ−Dₘᵢₙ)/Dₐᵥₑ, wherein respectively Dₐᵥₑ represents the average outer diameter of the ceramic susceptor wafer-support side, Dₘₐₓ, the maximum outer diameter along the thickness in an arbitrary plane; and Dₘᵢₙ, the minimum outer diameter along the thickness in the arbitrary plane (likewise in all of the embodiments hereinafter).

The temperature of each sample susceptor produced in this way was then raised to 500° C. by flowing a current at a voltage of 200 V into the resistive heating element through two electrodes formed on the surface of the susceptor opposite the wafer-support side. At that time a 0.8-mm thick, 300-mm diameter silicon wafer was placed on the wafer-support side of the ceramic susceptor, and the temperature distribution in the wafer surface was measured to find the temperature uniformity. The results obtained for each sample are set forth in Table I.

TABLE I

| | Outer-diameter fluctuation | Temperature uniformity (%) |
|---|---|---|
| Sample | parameter Dₚ (%) | of wafer surface at 500° C. |
| 1 | 0.007 | ±0.31 |
| 2 | 0.10 | ±0.36 |
| 3 | 0.30 | ±0.38 |
| 4 | 0.50 | ±0.41 |
| 5 | 0.80 | ±0.49 |
| 6* | 0.90 | ±0.55 |
| 7* | 1.20 | ±0.91 |

Note:
Samples marked with an asterisk (*) in the table are comparative examples.

As will be understood from the results set forth in Table I, in an AlN ceramic susceptor, by making the difference between a maximum outer diameter and minimum outer diameter along the thickness be 0.8% or less of the average outer diameter of the wafer-support side, the wafer surface temperature uniformity while the wafer is heated can be brought to within ±0.5%.

Embodiment 2

A sintering additive and a binder were added to, and dispersed into and mixed with, silicon nitride (Si₃N₄) powder using a ball mill. After drying with a spray dryer, the powder blend was press-molded into 1-mm thick, 380-mm diameter disks. The molded disks were degreased in a non-oxidizing atmosphere at a temperature of 800° C., and then sintered for 4 hours at 1550° C., producing sintered Si₃N₄ compacts. The thermal conductivity of the resulting Si₃N₄ sinters was 20 W/mK. The circumferential surface of each sintered Si₃N₄ compact was then polished to an outer diameter of 300 mm to prepare two Si₃N₄ substrates for a ceramic susceptor.

A paste of tungsten powder and sintering additive kneaded together with a binder was then print-coated on the surface of one of these Si₃N₄ substrates. This Si₃N₄ substrate was then degreased in a non-oxidizing atmosphere at a temperature of 800° C. and then baked at 1650° C., producing a tungsten resistive heating element. A layer of SiO₂ adhesive agent was formed on the surface of the remaining Si₃N₄ substrate, which was then degreased at 500° C. The adhesive layer of this Si₃N₄ substrate was then overlaid on the side of the Si₃N₄ substrate on which the resistive heating element was formed, and the substrates were bonded together by heating at 800° C., thereby producing a ceramic susceptor of Si₃N₄.

The circumferential surface of the ceramic susceptor produced by bonding was once more polished to yield a predetermined outer-diameter fluctuation parameter Dₚ at normal temperature. Having the configuration represented in FIG. 1, sample ceramic susceptors in which the outer-diameter fluctuation parameter Dₚ was varied as indicated in Table II were prepared as just described.

The temperature of each sample susceptor produced in this way was then raised to 500° C. by flowing a current at a voltage of 200 V into the resistive heating element through two electrodes formed on the surface of the susceptor opposite the wafer-support side. At that time the temperature distribution in the surface of a 0.8-mm thick, 300-mm diameter silicon wafer placed on the wafer-support side of the ceramic susceptor was measured to find the temperature uniformity. The results obtained for each sample are set forth in Table II.

TABLE II

| | Outer-diameter fluctuation | Temperature uniformity (%) |
|---|---|---|
| Sample | parameter Dₚ (%) | of wafer surface at 5000° C. |
| 8 | 0.007 | ±0.60 |
| 9 | 0.10 | ±0.72 |
| 10 | 0.30 | ±0.80 |
| 11 | 0.50 | ±0.88 |
| 12 | 0.80 | ±0.96 |
| 13* | 0.90 | ±1.20 |

Note:
Samples marked with an asterisk (*) in the table are comparative examples.

As will be understood from the results set forth in Table II, in a ceramic susceptor of silicon nitride, in which the thermal conductivity is 20 W/mK, by making the difference between a maximum outer diameter and minimum outer diameter along the thickness be 0.8% or less of the average outer diameter of the wafer-support side, a sought-after wafer surface temperature uniformity of within ±1.0% can be gained.

Embodiment 3

A sintering additive and a binder were added to, and dispersed into and mixed with, aluminum oxynitride (AlON) powder using a ball mill. After drying with a spray dryer, the powder blend was press-molded into 1-mm thick, 380-mm diameter disks. The molded disks were degreased in a non-oxidizing atmosphere at a temperature of 800° C., and then sintered for 4 hours at 1770° C., producing sintered AlON compacts. The thermal conductivity of the resulting AlON sinters was 20 W/mK. The circumferential surface of each sintered AlON compact was then polished to an outer diameter of 300 mm to prepare two AlON substrates for a ceramic susceptor.

A paste of tungsten powder and sintering additive kneaded together with a binder was then print-coated on the surface of one of these AlON substrates to form a predetermined circuit pattern for a heating element. This AlON substrate was then degreased in a non-oxidizing atmosphere at a temperature of 800° C. and baked at 1700° C., producing a tungsten resistive heating element. A paste of Y₂O₃ adhesive agent kneaded with a binder was print-coated on the surface of the remaining AlON substrate, which was then degreased at 500° C. The adhesive layer of this AlON substrate was then overlaid on the side of the AlON substrate on which the resistive heating element was formed, and the substrates were bonded together by heating at 800° C., thereby producing a ceramic susceptor of AlON.

The circumferential surface of the ceramic susceptor produced by bonding was once more polished to yield a predetermined outer-diameter fluctuation parameter Dₚ at normal temperature. Having the configuration represented in FIG. 1, sample ceramic susceptors in which the outer-diameter fluctuation parameter Dₚ was varied as indicated in Table III were prepared as just described above.

The temperature of each sample susceptor produced in this way was then raised to 500° C. by flowing a current at a voltage of 200 V into the resistive heating element through two electrodes formed on the surface of the susceptor opposite the wafer-support side. At that time the temperature distribution in the surface of a 0.8-mm thick, 300-mm diameter silicon wafer placed on the wafer-support side of the ceramic susceptor was measured to find the temperature uniformity. The results obtained for each sample are collectively set forth in Table III.

TABLE III

| | Outer-diameter fluctuation | Temperature uniformity (%) |
|---|---|---|
| Sample | parameter Dₚ (%) | of wafer surface at 500° C. |
| 14 | 0.007 | ±0.66 |
| 15 | 0.10 | ±0.72 |
| 16 | 0.30 | ±0.84 |
| 17 | 0.50 | ±0.90 |
| 18 | 0.80 | ±0.99 |
| 19* | 0.90 | ±1.18 |

Note:
Samples marked with an asterisk (*) in the table are comparative examples.

As will be understood from the results set forth in Table III, in a ceramic susceptor of aluminum oxynitride, in which the thermal conductivity is 20 W/mK, by making the difference between a maximum outer diameter and minimum outer diameter along the thickness be 0.8% or less of the average outer diameter of the wafer-support side, a sought-after temperature uniformity in the wafer surface of within ±1.0% can be gained.

Embodiment 4

Pairs of AlN substrates for a ceramic susceptor with a 300 mm outer diameter were prepared from a sintered aluminum nitride material using the same method described in the first embodiment. When sample ceramic susceptors were made using these AlN substrate pairs, the material of the resistive heating element formed on the surface of one AlN substrate was changed to Mo, to Pt, to Ag—Pd, and to Ni—Cr. Pastes of these materials were print-coated on one AlN substrate of each pair, and the substrates were fired within a non-oxidizing atmosphere.

A SiO₂ glass bonding agent was then coated over the surface of the remaining AlN substrate in each pair, which was degreased in a non-oxidizing atmosphere at 800° C. The adhesive glass layer of this AlN substrate was then overlaid on the side of the AlN substrate on which the resistive heating element was formed, and the substrate pairs were bonded together by heating at 800° C., producing ceramic susceptors of AlN.

The circumferential surface of each sample ceramic susceptor obtained was once more polished to yield a predetermined outer-diameter fluctuation parameter Dₚ at normal temperature. Having the configuration represented in FIG. 1, sample ceramic susceptors in which the outer-diameter fluctuation parameter Dₚ was varied as indicated in Table IV were prepared as just described.

The temperature of each sample susceptor produced in this way was then raised to 500° C. by flowing a current at a voltage of 200 V into the resistive heating element through two electrodes formed on the surface of the susceptor opposite the wafer-support side. At that time the temperature distribution in the surface of a 0.8-mm thick, 300-mm diameter silicon wafer placed on the wafer-support side of the ceramic susceptor was measured to find the temperature uniformity. The results obtained for each sample are collectively set forth in Table IV.

TABLE IV

| | | Outer-diameter | Temperature |
|---|---|---|---|
| | Resistive heating | fluctuation | uniformity (%) of wafer |
| Sample | element | parameter Dₚ (%) | surface at 500° C. |
| 20 | Mo | 0.007 | ±0.29 |
| 21 | Mo | 0.10 | ±0.34 |
| 22 | Mo | 0.30 | ±0.38 |
| 23 | Mo | 0.50 | ±0.41 |
| 24 | Mo | 0.80 | ±0.50 |
| 25* | Mo | 0.90 | ±0.61 |
| 26 | Pt | 0.007 | ±0.31 |
| 27 | Pt | 0.10 | ±0.36 |
| 28 | Pt | 0.30 | ±0.39 |
| 29 | Pt | 0.50 | ±0.43 |
| 30 | Pt | 0.80 | ±0.49 |
| 31* | Pt | 0.90 | ±0.62 |
| 32 | Ag—Pd | 0.007 | ±0.30 |
| 33 | Ag—Pd | 0.10 | ±0.36 |
| 34 | Ag—Pd | 0.30 | ±0.39 |
| 35 | Ag—Pd | 0.50 | ±0.41 |
| 36 | Ag—Pd | 0.80 | ±0.49 |
| 37* | Ag—Pd | 0.90 | ±0.60 |
| 38 | Ni—Cr | 0.007 | ±0.31 |
| 39 | Ni—Cr | 0.10 | ±0.35 |
| 40 | Ni—Cr | 0.30 | ±0.38 |
| 41 | Ni—Cr | 0.50 | ±0.40 |
| 42 | Ni—Cr | 0.80 | ±0.50 |
| 43* | Ni—Cr | 0.90 | ±0.59 |

Note:
Samples marked with an asterisk (*) in the table are comparative examples.

It will be understood from the results set forth in Table IV that whether the resistive heating element is made of tungsten as in the Embodiment 1 or is made of Mo, Pt, Ag—Pd, or Ni—Cr as here, favorable wafer surface temperature uniformity while a wafer is being heated can be had by making the difference between a maximum outer diameter and minimum outer diameter along the thickness be 0.8% or less of the average outer diameter of the wafer-support side.

Embodiment 5

A sintering additive, a binder, a dispersing agent and alcohol were added to an aluminum nitride (AlN) powder and kneaded into a paste, which then underwent doctor-blading formation to yield multiple green sheets approximately 0.5 mm thick.

Next the green sheets were dried for 5 hours at 80° C. A paste of tungsten powder and sintering additive kneaded together with a binder was then print-coated on the surface of single plies of the green sheets to form a layer of a resistive heating element in a predetermined circuit pattern. Second plies of the green sheets were likewise dried and the same tungsten paste was print-coated onto a surface thereof to form a plasma electrode layer. These two plies of green sheets each having a conductive layer were then laminated in a total 50 plies with green sheets that were similarly dried but that were not printed with a conductive layer, and the laminates were united by heating them at a temperature of 140° C. while applying a pressure of 70 kg/cm².

The resulting laminates were degreased for 5 hours at 600° C. in a non-oxidizing atmosphere, then hot-pressed at 1800° C. while applying pressure of 100 to 150 kg/cm², thereby producing 3-mm thick AlN plates. These plates were then cut to form 380-mm diameter disks. The periphery of each disk was then polished to a 300 mm diameter, producing ceramic susceptors of the structure in FIG. 2, having an internal resistive heating element and plasma electrode made of tungsten.

The circumferential surface of the ceramic susceptor obtained was then polished to yield a predetermined outer-diameter fluctuation parameter Dₚ at normal temperature. Having the configuration represented in FIG. 2, sample ceramic susceptors in which the outer-diameter fluctuation parameter Dₚ was varied as indicated in Table V were prepared as just described.

The temperature of each sample susceptor produced in this way was then raised to 500° C. by flowing a current at a voltage of 200 V into the resistive heating element through two electrodes formed on the surface of the susceptor opposite the wafer-support side. At that time the temperature distribution in the surface of a 0.8-mm thick, 300-mm diameter silicon wafer placed on the wafer-support side of the ceramic susceptor was measured to find the temperature uniformity. The results obtained for each sample are collectively set forth in Table V.

TABLE V

| | Outer-diameter fluctuation | Temperature uniformity (%) |
|---|---|---|
| Sample | parameter Dₚ (%) | of wafer surface at 500° C. |
| 44 | 0.007 | ±0.31 |
| 45 | 0.10 | ±0.36 |
| 46 | 0.30 | ±0.39 |
| 47 | 0.50 | ±0.43 |
| 48 | 0.80 | ±0.49 |
| 49* | 0.90 | ±0.59 |

Note:
Samples marked with an asterisk (*) in the table are comparative examples.

As will be understood from the results set forth in Table V, also with a ceramic susceptor having an internal resistive heating element and plasma electrode favorable wafer-surface temperature uniformity when a wafer is being heated can be gained by making the difference between a maximum outer diameter and minimum outer diameter along the thickness be 0.8% or less of the average outer diameter of the susceptor wafer-support side.

### INDUSTRIAL APPLICABILITY

In accordance with the present invention, keeping outer-diameter fluctuation along the thickness of a ceramic susceptor when at normal temperature affords for semiconductor manufacturing equipment a ceramic susceptor whereby wafer-surface temperature uniformity during heating operations is enhanced.

1. For heating operations in semiconductor manufacturing equipment, a ceramic susceptor comprising:
a ceramic substrate defining a wafer-support side and being processed so that when the susceptor is not heating, along the susceptor thickness the difference between the maximum outer diameter and the minimum outer diameter in an arbitrary plane is 0.8% or less of the average outer diameter along the susceptor wafer-support side; and
a resistive heating element provided either on a surface of or inside said ceramic substrate.

2. A ceramic susceptor for semiconductor manufacturing equipment as set forth in claim 1, wherein the ceramic substrate is made of at least one ceramic selected from aluminum nitride, silicon nitride, aluminum oxynitride, and silicon carbide.

3. A ceramic susceptor for semiconductor manufacturing equipment as set forth in claim 1, wherein the resistive heating element is made from at least one metal selected from tungsten, molybdenum, platinum, palladium, silver, nickel, and chrome.

4. A ceramic susceptor for semiconductor manufacturing equipment as set forth in claim 1, wherein a plasma electrode is further disposed on a surface of or inside the ceramic substrate.

5. A ceramic susceptor for semiconductor manufacturing equipment as set forth in claim 2, wherein the resistive heating element is made from at least one metal selected from tungsten, molybdenum, platinum, palladium, silver, nickel, and chrome.

6. A ceramic susceptor for semiconductor manufacturing equipment as set forth in claim 2, wherein a plasma electrode is further disposed on a surface of or inside the ceramic substrate.

7. A ceramic susceptor for semiconductor manufacturing equipment as set forth in claim 3, wherein a plasma electrode is further disposed on a surface of or inside the ceramic substrate.

8. A ceramic susceptor for semiconductor manufacturing equipment as set forth in claim 5, wherein a plasma electrode is further disposed on a surface of or inside the ceramic substrate.
